(19) United States
(12) Patent Application Publication
(10) Pub. No.: US 2009/0204575 A1
(43) Pub. Date: Aug. 13, 2009

(54) MODULAR WEB CRAWLING POLICIES AND METRICS

(76) Inventors: CHRISTOPHER OLSTON, Mountain View, CA (US); Andrew Tomkins, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/027,860

(22) Filed: Feb. 7, 2008

(51) Int. Cl. G06F 17/30

(52) U.S. Cl. 707/3; 707/E17.108

(57) ABSTRACT

A web crawler loads a policy from a customizable stored module that is separate and distinct from the web crawler's source code. The web crawler follows these policies in determining the order in which the web crawler will visit and index web pages in an index used by an Internet search engine. As a result, the web crawler's behavior can be modified more easily. The web crawler's behavior can be finely tuned to be more efficient and/or to accommodate the particular needs of the search engine. Multiple different policies may be maintained concurrently in separate stored modules, and the web crawler can be instructed to use different modules' policies at different specified times or under different specified circumstances.

### FIELD OF THE INVENTION

The present invention relates to search engines, and, more specifically, to modular web crawling policies and metrics, and to evaluating fetch ordering policies for web crawlers.

### BACKGROUND

An abundance of information is available via the Internet. Users can direct web browser applications, such as Mozilla Firefox, to various Uniform Resource Locators (URLs) in order to view content that is associated with those URLs. In order to assist users in locating certain kinds of content for which the users do not know the associated URLs, various Internet search engines have emerged. Yahoo! is the owner and operator of one of these Internet search engines.

A user can enter a set of query terms into an Internet search engine's user interface. The Internet search engine receives the query terms and searches an index for known content items that are associated with the query terms. The Internet search engine creates a list of content items that are relevant to the submitted query terms. The Internet search engine returns the list to the user.

The index that the search engine searches is typically populated automatically by a mechanism called a “web crawler.” A web crawler is a program that automatically and continuously follows the hypertext links in a web page to other web pages. In following these hypertext links from web page to web page, the web crawler may discover new web pages or updated web pages that are accessible via the Internet. Additionally, the web crawler may discover that a web page that was previously indexed no longer exists and is no longer accessible. As the web crawler discovers new, changed, or removed web pages, the web crawler updates the index with the web page information that the web crawler has discovered.

Many web pages change on a daily basis, or even more frequently (e.g., news, blogs, and bulletin board systems). The frequency with which the web crawler updates the index influences the accuracy and freshness of search results eventually generated by the search engine. If significant portions of the index have not been updated for a significant period of time, then the search engine may return search results that are inaccurate or stale (e.g., the web pages to which the search results refer no longer exist or have changed significantly in content).

Thus, if a search engine is to be perceived by its users as being useful, the web crawler ought to revisit indexed web pages and update the index as frequently as possible. However, the number of web pages accessible through the Internet is immensely vast, and the quantity of web pages that a web crawler can visit in a certain period of time is limited by (a) the processing power of the computers on which the web crawler executes and (b) the network communication bandwidth available to those computers. Thus, a web crawler often benefits from being selective in the order in which the web crawler will revisit web pages in the index. To this end, a web crawler might be programmed to follow a “policy” that informs the web crawler as to the order in which the web crawler ought to revisit web pages in the index.

Currently, the policies that web crawlers follow in revisiting web pages have been “hard coded” into those web crawlers. One undesirable effect of this hard coding is the difficulty with which a web crawler's policy can be changed. When a web crawler's policy is hard coded (i.e., determined by the web crawler's source code) into the web crawler, changing the web crawler's policy might require altering the web crawler's source code and recompiling the web crawler. Such tasks can be time consuming and may require considerable programming expertise and familiarity with the source code.

The present difficulty that attends modifying the policy that a web crawler follows deters people from “evolving” web crawler to crawl the Internet in better, more efficient ways. Indeed, given the present state of web crawlers, programmers and others might find it difficult to determine even how a web crawler's policy ought to be modified to improve the web crawler's efficiency.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Various embodiments of the present invention are illustrated by way of example, and not by way of limitation, in the figures of the accompanying drawings and in which like reference numerals refer to similar elements and in which:

FIGS. 1-2 are flow diagrams that illustrate techniques for modularized, concurrent, policy-based web crawling, according to an embodiment of the invention;

FIG. 3 is a block diagram that illustrates a computer system upon which an embodiment of the invention may be implemented; and

FIG. 4 is a flow diagram that illustrates a technique for concurrently executing multiple web crawlers that each follow different policies, according to an embodiment of the invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

According to techniques described herein, a web crawler loads one or more policies from one or more customizable stored modules that are separate and distinct from the web crawler and the web crawler's source code. The web crawler follows these policies in determining the order in which the web crawler will revisit or “fetch” web pages in an index used by an Internet search engine. The web crawler also follows these policies in determining the order in which the web crawler will traverse links to web pages that the web crawler has not yet visited. As a result of these techniques, the web crawler's behavior can be modified more easily. The web crawler's behavior can be finely tuned to be more efficient and/or to accommodate the particular needs of the search engine. According to one technique, multiple different policies may be maintained concurrently in separate stored modules, and the web crawler can be instructed to use different modules' policies at different specified times or under different specified circumstances. Thus, different policy modules can be “plugged into” a web crawler at different times in order to control or influence the web crawler's behavior.

According to other techniques described herein, a web crawler automatically records various measurements as the web crawler visits web pages. The measurements that the web crawler records may be dictated by the modular policies that the web crawler follows. People and automated programs may scrutinize the recorded measurements in order to determine how the web crawler's policy ought to be altered in order to evolve the web crawler's behavior in its progression toward a desired goal.

### Policy-based Choice of which Links to Traverse First

The immense number of web pages that can be accessed on the Internet practically prevents a web crawler from discovering every Internet-accessible web page in any short period of time. In attempting to discover new web pages, a web crawler typically traverses links that are found in the web pages that the web crawler has already discovered. However, there may be a sufficiently large number of such links that the web crawler might not be able to visit all such links within a reasonable amount of time. Therefore, it is often more practical to provide the web crawler with a policy that the web crawler can use to determine which link, of a plurality of known but untraversed links, the web crawler should traverse next. Based on such a policy, a web crawler may rank the untraversed links in order of importance, and then traverse the links that are deemed to be the most important first, thus discovering the most important web pages first and adding those web pages to the search index first. Among the links on a particular web page, one link might be more important than the others.

For example, a policy might indicate that the importance of a particular web page is based on the number of distinct links to that particular web page. Under such a policy, a web crawler would choose to visit or “fetch” a web page to which thirty distinct links pointed before visiting another web page to which only one or two links pointed. Given a set of links that the web crawler could traverse, the web crawler would choose to traverse one of the thirty links to the more important web page before traversing one of the few links to the less important web page.

For another example, a policy might indicate that a particular link's importance is based on the frequency with which words in that particular link's anchor text are also found in previously submitted search queries that in the past have returned few or no search results (referred to below as “low-result queries”). Under such a policy, a web crawler would choose to traverse a link whose anchor text contained words that appeared in many low-result queries before traversing a link whose anchor text contained only words that did not appear in any low-result queries. The goal of such a policy would be to populate the search index with web pages that probably could be returned as search results for such historically low-result queries in the future, so that in the future those queries would no longer be low-result queries.

Because the policies and the modules that express those policies are, in one embodiment of the invention, separate and distinct from the web crawler itself, the web crawler does not need to be re-coded or re-compiled each time that a user wants the web crawler to use a different policy. Instead, the user can instruct (e.g., via a command-line interface) the same web crawler, or different instances of the same web crawler, to use different policies at different times. Because the policies that a web crawler uses can be changed, in one embodiment of the invention, without changing the web crawler itself, the web crawler of such an embodiment of the invention is said to be “extensible.”

### Concurrently Executing Web Crawlers Following Different Policies

In one embodiment of the invention, multiple web crawlers execute on one or more machines concurrently. These web crawlers may use and populate the same search index. In one embodiment of the invention, each of the multiple concurrently executing web crawlers follows a different policy. Each such policy may indicate the fraction of the total available computing resources (e.g., CPU time, memory, persistent storage, network bandwidth) that the web crawler following that policy is permitted to consume.

For example, a set of computing resources (e.g., one or more computers communicatively coupled together in a network, and/or one or more processors communicatively coupled together via a bus) might be made available to three separate, concurrently executing web crawlers. The first web crawler might follow a policy that indicates that the first web crawler can utilize 20% of the set of computing resources. The second web crawler might follow a policy that indicates that the second web crawler can utilize 30% of the set of computing resources. The third web crawler might follow a policy that indicates that the third web crawler can utilize 50% of the set of computing resources.

Each of the policies followed by the respective web crawler may differ, so that each of the web crawlers not only uses a different fraction of the set of computing resources, but also so that each of the web crawlers determines link and web page importance in a different manner for the purpose of determining which link or web page should be visited next. Each different policy may be expressed in a separate module. At the time that each web crawler is started, that web crawler may be told (e.g., via a command-line interface) an identity of a module from which that web crawler should load the policy that the web crawler is to follow. In one embodiment of the invention, each module is a separate file.

In one embodiment of the invention, a resource manager allocates computing resources to the concurrently executing web crawlers based on a specified scheme. Such a scheme may be indicated in the policy modules themselves (as is described above) or in a master file that is external to all of the policy modules.

### Policy-expressed Internet Partitions

In one embodiment of the invention, each of the concurrently executing web crawlers chooses, from the same set of web pages and links, the web page or link to visit or traverse next. However, in an alternative embodiment of the invention, each policy indicates a subset (or partition) of all Internet-accessible content, such that the subset contains fewer than all of the web pages that are accessible via the Internet. In such an alternative embodiment of the invention, a particular web crawler only visits and traverses web pages and links that fall within the policy-specified subset. For example, a particular policy might indicate a specified domain name. Under such circumstances, the web crawler that is following that particular policy might visit only web pages that are contained within the domain indicated by the specified domain name. The web crawler that is following that particular policy might traverse only link that point to web pages that are contained within the domain indicated by the specified domain name.

In such an alternative embodiment of the invention, each policy may specify a different subset of all of the web pages that are accessible via the Internet. The subsets specified by the different policies might or might not intersect. In one embodiment of the invention, web crawlers are not restricted to visiting web pages that are within those web crawler's policy-specified subsets, but, instead, the web crawlers determine the importance of web pages that those web crawlers could visit based at least in part on whether those web pages are contained within those web crawler's policy-specified subsets. As a result, a particular web crawler might choose to visit a web page that is contained within that particular web crawler's policy-specified subset before visiting any web page that is not contained within that particular web crawler's policy-specified subset.

### Modularized Metrics

In one embodiment of the invention, when a web crawler is executed (or while that web crawler is executing), a user instructs the web crawler to load and use a stored set of metrics. There might be several different stored sets of metrics that a particular web crawler could load and use. For example, each separate set of metrics might be stored in a separate file that a particular web crawler could load when instructed to do so.

In one embodiment of the invention, after loading a particular set of metrics, the web crawler generates and stores measurements and/or statistics that are relevant to those metrics. Thus, by instructing a web crawler to load a particular set of metrics, the user can control which aspects of web crawling behavior the web crawler measures and reports. If multiple separate web crawlers are executing concurrently, a user can instruct each of the web crawlers to load and use a different set of metrics. Because the sets of metrics are separate and distinct from the web crawler itself, the web crawler does not need to be re-coded or re-compiled each time that a user wants the web crawler to use a different set of metrics. Instead, the user can instruct (e.g., via a command-line interface) the same web crawler, or different instances of the same web crawler, to use different sets of metrics at different times. Because the metrics that a web crawler uses can be changed, in one embodiment of the invention, without changing the web crawler itself, the web crawler of such an embodiment of the invention is said to be “extensible.”

Different sets of metrics may cause web crawlers to measure and record different facts and statistics. For example, a set of metrics might cause a web crawler that loaded that set to measure and record, periodically, a rate, in pages per second, that the web crawler visits and/or indexes web pages. For another example, a set of metrics might cause a web crawler that loaded that set to measure and record, periodically, the “freshness” of the web pages that the web crawler visits (e.g., whether such web pages have been updated or modified since the last time that a web crawler visited those web pages).

### Competitive and Collaborative Policies

In one embodiment of the invention, each of the policies in a plurality of policies is designed to compete with each other of the policies. Under such circumstances, a user or organization might instruct separate web crawler nodes to utilize different policies when web crawling so that the user or organization can determine which of the policies best achieves a desired goal (e.g., crawling the most web pages in a specified amount of time, or filling a search index with web pages that are relevant to historically low-result queries). In one such embodiment of the invention, while multiple web crawler nodes are concurrently web crawling based on different policies, measurements of specified web crawling metrics are made for each of those web crawlers, and computing resources are adjusted “on the fly” based on the observed measurement, so that more computing resources are dynamically allocated to web crawler nodes that are following policies for which the most favorable measurements (according to some specified goal) have been observed up to that point in time.

In an alternative embodiment of the invention, each of the policies in the plurality of policies is designed to aid and assist one or more of the other policies. For example, a first web crawler following one policy might obtain the output of a second web crawler that is following another policy. The policy followed by the first web crawler might cause the first web crawler to further process or use the results of the processing performed by the second web crawler. A third web crawler, following yet another policy, might obtain the output of the first web crawler. The policy followed by the third web crawler might cause the third web crawler to further process or use the results of the processing performed by the first web crawler. All three web crawler might be separate instances of the same executable code, but each of the three web crawlers may load and utilize different policies from different modules. Although one web crawler might obtain and use output of another web crawler, the actions of the web crawlers may be asynchronous and decoupled, such that one web crawler obtains and processes the output of another web crawler as that output becomes available and as the former web crawler has the computing resources to do so.

### Policy Expression Forms

According to various embodiments of the invention, policies may be expressed in various different ways. For example, policies may be expressed as executable code (separate from the executable code of the web crawler itself). For another example, policies may be expressed in terms of a defined constraint language and/or predicate calculus statements. For another example, policies may be expressed in a dataflow language such as relational algebra.

### Example Techniques

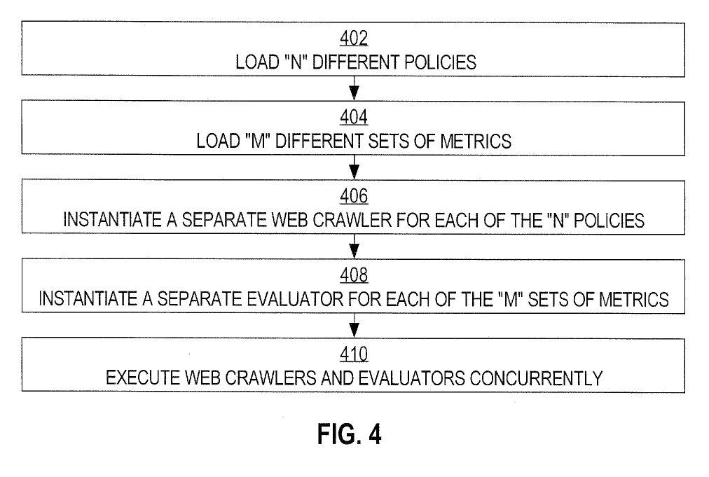

FIG. 4 is a flow diagram that illustrates a technique for concurrently executing multiple web crawlers that each follow different policies, according to an embodiment of the invention. In block 402, some number “N” of different policies are loaded from files. In block 404, some number “M” of different sets of metrics are loaded from files. In block 406, a separate web crawler is instantiated for each of the “N” policies. Each such web crawler follows a different one of the “N” policies. In block 408, a separate evaluator (which may be implemented as a process executing on a computer) is instantiated for each of the “M” sets of metrics. Each such evaluator makes measurements using a different one of the “M” sets of metrics. In block 410, the web crawlers and evaluators all execute concurrently, and read from and write to the same search index. The evaluators evaluate the web crawlers (and the policies that those web crawlers follow) by recording measurements of the metrics that those evaluators loaded. Each evaluator may evaluate multiple web crawlers.

In one embodiment of the invention, a centralized controller module loads each of the “N” policies and spawns each of the “N” web crawlers. The centralized controller module instructs (e.g., via command-line parameters) each spawned web crawler to use a specified policy. Each policy specifies a set of rules for fetching web pages. For example, different sets of rules may indicate different algorithms for determining the importance of web pages relative to each other and the order in which those web pages ought to be fetched. Although the controller module may spawn the web crawlers at different times, in one embodiment of the invention, the web crawlers spawned by the centralized controller module each execute concurrently during at least some interval of time.

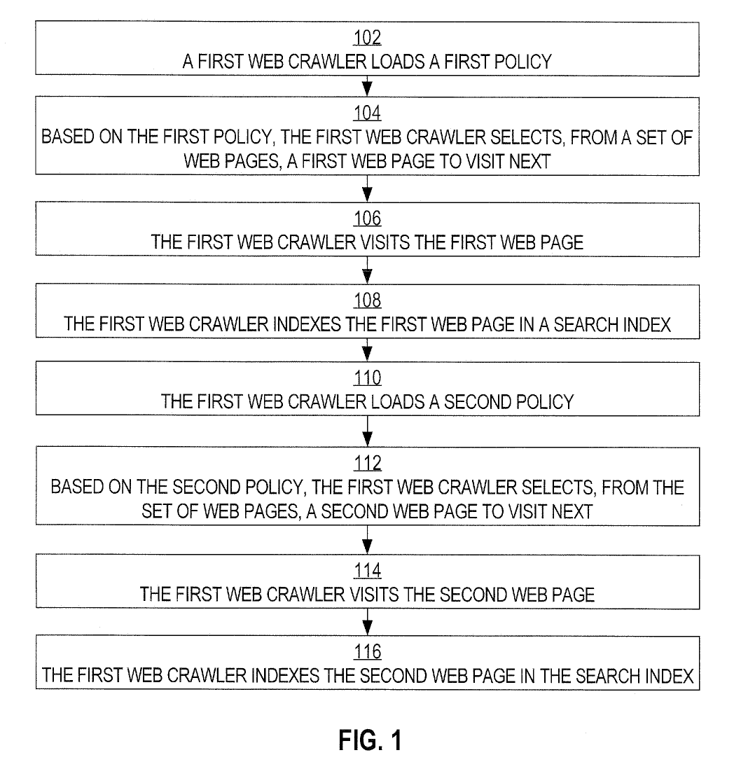

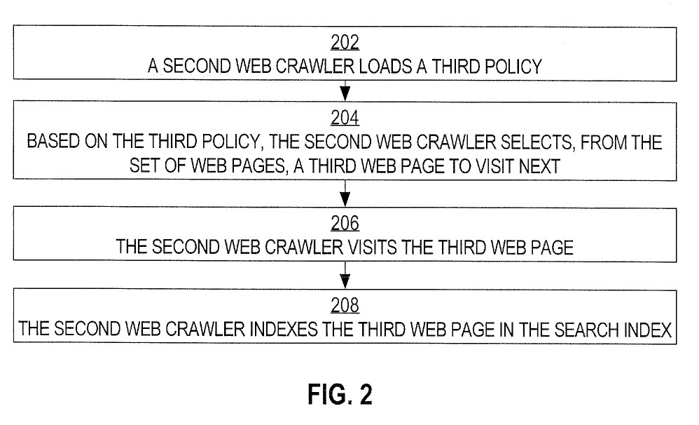

FIGS. 1-2 are flow diagrams that illustrate techniques for modularized, concurrent, policy-based web crawling, according to an embodiment of the invention. Alternative embodiments of the invention may involve more, fewer, or different steps than those illustrated in FIGS. 1-2. In one embodiment of the invention, the technique of FIG. 1 is performed by a first of the web crawlers discussed above with reference to FIG. 4, at the same time that the technique of FIG. 2 is being performed by a second of the web crawlers discussed above with reference to FIG. 4.

Referring first to FIG. 1, FIG. 1 shows a technique that may be performed by a first web crawler process concurrently with the technique of FIG. 2 being performed by a second web crawler process. In block 102, a first web crawler loads a first policy. The first policy is, in one embodiment of the invention, expressed in a file that is separate from the first web crawler's executable code.

In block 104, based at least in part on the first policy, the first web crawler selects, from a set of web pages, a first web page to visit next. Additionally or alternatively, based at least in part on the first policy, the first web crawler may select, from a set of hyperlinks, a first hyperlink to traverse next.

In one embodiment of the invention, the first policy expresses a subset of web pages. For example, the first policy might express the subset by expressing a particular Internet domain. The subset contains fewer than all of the web pages that are accessible via the Internet (e.g., only those web pages that are contained in the specified Internet domain). In such an embodiment of the invention, the first web crawler selects the first web page from the subset of web pages.

In block 106, the first web crawler visits the first web page. The first web crawler may visit the first web page by requesting, fetching, and/or loading the first web page, for example. As is discussed above, the first web crawler may use the services of a utility server in order to perform these tasks.

In block 108, the first web crawler indexes the first web page in a search index that an Internet search engine uses to determine sets of web pages that are relevant to user-submitted search queries. For example, the first web crawler may store the first web page on a persistent storage device, and store an association between the first web page and the first web page's URL in a search index that is stored on the persistent storage device.

In block 110, the first web crawler loads a second policy. The second policy differs from the first policy. The second policy is, in one embodiment of the invention, expressed in a file that is separate from the first web crawler's executable code. The second policy is, in one embodiment of the invention, expressed in a file that is separate from the file in which the first policy is expressed. By loading a different policy, the first web crawler's behavior may be changed.

In block 112, based at least in part on the second policy, the first web crawler selects, from the set of web pages, a second web page to visit next. Additionally or alternatively, based at least in part on the second policy, the first web crawler may select, from the set of hyperlinks, a second hyperlink to traverse next.

In one embodiment of the invention, the second policy also expresses a subset of web pages. The subset contains fewer than all of the web pages that are accessible via the Internet (e.g., only those web pages that are contained in the specified Internet domain). In such an embodiment of the invention, the first web crawler selects the second web page from the subset of web pages expressed in the second policy. The subset of web pages expressed in the second policy differs, in one embodiment of the invention, from the subset of web pages expressed in the first policy discussed above. In one embodiment of the invention, although the subsets expressed in the first and second policies differ, these subsets intersect at least partially.

In block 114, the first web crawler visits the second web page. The first web crawler may visit the second web page by requesting, fetching, and/or loading the second web page, for example. As is discussed above, the first web crawler may use the services of a utility server in order to perform these tasks.

In block 116, the first web crawler indexes the second web page in the search index. For example, the first web crawler may store the second web page on a persistent storage device, and store an association between the second web page and the second web page's URL in the search index.

Referring next to FIG. 2, FIG. 2 shows a technique that may be performed by a second web crawler process concurrently with the technique of FIG. 1 being performed by the first web crawler process.

In block 202, a second web crawler loads a third policy. The third policy is, in one embodiment of the invention, expressed in a file that is separate from the second web crawler's executable code. In one embodiment of the invention, the second web crawler is an executing process that is separate from the first web crawler, but the first and second web crawlers are separate instances of the same program in that they share the same executable code. The third policy differs, in one embodiment of the invention, from both the first and second policies discussed above.

In block 204, based at least in part on the third policy, the second web crawler selects, from the set of web pages, a third web page to visit next. Additionally or alternatively, based at least in part on the third policy, the first web crawler may select, from a set of hyperlinks, a third hyperlink to traverse next.

In block 206, the second web crawler visits the third web page. The second web crawler may visit the third web page by requesting, fetching, and/or loading the third web page, for example. As is discussed above, the second web crawler may use the services of a utility server in order to perform these tasks.

In block 208, the second web crawler indexes the third web page in the search discussed above. Thus, several concurrently executing web crawlers may all populate the same search index. For example, the second web crawler may store the third web page on a persistent storage device, and store an association between the third web page and the third web page's URL in the search index.

In one embodiment of the invention, the policies loaded by the first and second web crawlers each specify a fraction, ratio, percentage, or quantity of computing resources that the followers of those policies are permitted to consume. In such an embodiment of the invention, a server enforces resource utilization constraints on each of the executing web crawlers by ensuring that each web crawler uses no more than the fraction or quantity of computing resources that is permitted by the policy that the web crawler is currently following.

In one embodiment of the invention, the policies loaded by the first and second web crawlers each specify a set of metrics. The set of metrics specified in each policy may differ. In such an embodiment of the invention, each web crawler measures and records facts and statistics based on the set of metrics that is specified in the policy that the web crawler is currently following. The facts and statistics recorded pertain to the web crawler's web-crawling behavior (e.g., the number of pages visiting in an amount of time, the “freshness” of the pages visited, etc.). Because the policies being followed by the web crawlers may differ, the facts and statistics recorded by each web crawler may differ in the kind of facts and statistics recorded (although it is possible for two or more policies to specify the same set of metrics also).

By evaluating the facts and statistics recorded by each web crawler, and by causing multiple web crawlers to execute concurrently and follow different policies, an administrator of an Internet search engine can determine which of the policies is better at achieving the administrator's desired goal, whatever that goal may be. The administrator might make a change in a policy and test that change against the unchanged policy in order to determine whether the results produced by the change are desirable or not. When the policies express orders in which web crawlers should fetch web pages (e.g., by expressing rules for determining the importance of each web page that could be fetched next), the administrator can observe the facts and statistics recorded by each web crawler in order to evaluate the fetch ordering policies.

### Hardware Overview

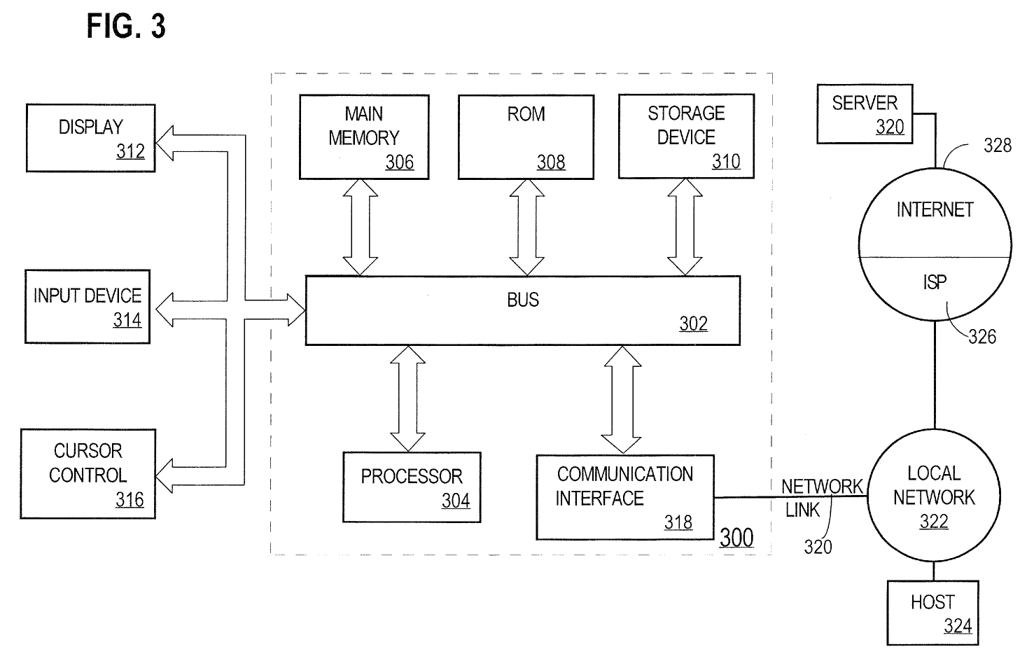

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to storage media and transmission media. Storage media includes both non-volatile media and volatile media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
a first web crawler loading a first policy that is expressed in a first file that is separate from the first web crawler's executable code; and
the first web crawler selecting, from a set of web pages, a first web page to visit next based at least in part on the first policy.

2. The method of claim 1, wherein the first web page is located at a URL that is indicated in a link that was extracted from another web page.

3. The method of claim 1, further comprising:
the first web crawler visiting the first web page;
the first web crawler indexing the first web page in an index that a search engine searches;
subsequent to the first web crawler indexing the first web page, the first web crawler loading a second policy that is expressed in a second file that is separate from both (a) the first web crawler's executable code and (b) the first file;
the first web crawler selecting, from the set of web pages, a second web page to visit next based at least in part on the second policy;
the first web crawler visiting the second web page; and
the first web crawler indexing the second web page in the index;
wherein the second policy differs from the first policy.

4. The method of claim 3, wherein the first policy indicates that a particular web page to be visited next is to be selected based at least in part on a number of links that point to the particular web page, and wherein the second policy indicates that a certain web page to be visited next is to be selected based at least in part on a number of previously submitted search queries that contain one or more words that are in anchor text of a link that points to the certain web page.

5. The method of claim 1, wherein the first policy specifies a subset of web pages that is smaller than a set of all web pages that are Internet-accessible, and wherein the step of the first web crawler selecting the first web page to visit next comprises the first web crawler selecting the first web page from the subset of web pages.

6. The method of claim 5, further comprising:
the first web crawler visiting the first web page;
the first web crawler indexing the first web page in an index that a search engine searches;
subsequent to the first web crawler indexing the first web page, the first web crawler loading a second policy that is expressed in a second file that is separate from both (a) the first web crawler's executable code and (b) the first file;
the first web crawler selecting, from a second subset of web pages, a second web page to visit next based at least in part on the second policy;
the first web crawler visiting the second web page; and
the first web crawler indexing the second web page in the index;
wherein the second policy specifies the second subset of web pages;
wherein the second subset of web pages differs from the first subset of web pages.

7. The method of claim 1, further comprising:
a second web crawler loading a second policy that is expressed in a second file that is separate from the second web crawler's executable code; and
the second web crawler selecting, from the set of web pages, a second web page to visit next based at least in part on the second policy;
wherein the second web crawler is separate from the first web crawler;
wherein the second web crawler has the same executable code as the first web crawler; and
wherein the second policy differs from the first policy.

8. The method of claim 7, wherein the second web crawler executes concurrently with the first web crawler, and wherein the step of the second web crawler selecting the second web page is performed concurrently with the step of the first web crawler selecting the first web page.

9. The method of claim 7, wherein the second web crawler executes concurrently with the first web crawler, wherein the first policy specifies a fraction of a set of computing resources that the first web crawler is permitted to utilize, and wherein the second policy specifies a fraction of a set of computing resources that the second web crawler is permitted to utilize.

10. The method of claim 1, further comprising:
the first web crawler loading a first set of metrics that is expressed in a second file that is separate from the first web crawler's executable code;
a second web crawler loading a second set of metrics that is expressed in a third file that is separate from the second web crawler's executable code;
the first web crawler measuring and storing measurements that pertain to the first set of metrics; and
the second web crawler measuring and storing measurements that pertain to the second set of metrics;
wherein the first set of metrics differs from the second set of metrics;
wherein the first web crawler is separate from the second web crawler; and
wherein the second web crawler has the same executable code as the first web crawler.

11. A computer-implemented method comprising:
a controller module loading a first policy that indicates rules for fetching web pages;
the controller module spawning a first web crawler in a manner that instructs the first web crawler to visit web pages according to the first policy;
the controller module loading a second policy that indicates rules for fetching web pages; and
the controller module spawning a second web crawler in a manner that instructs the second web crawler to visit web pages according to the second policy;
wherein the first policy differs from the second policy; and
wherein the first web crawler executed concurrently with the second web crawler.

12. A volatile or non-volatile computer-readable storage medium carrying one or more sequences of instructions which, when executed by one or more processors, cause the one or more processors to perform the steps recited in claim 1.

13. A volatile or non-volatile computer-readable storage medium carrying one or more sequences of instructions which, when executed by one or more processors, cause the one or more processors to perform the steps recited in claim 2.

14. A volatile or non-volatile computer-readable storage medium carrying one or more sequences of instructions which, when executed by one or more processors, cause the one or more processors to perform the steps recited in claim 3.

15. A volatile or non-volatile computer-readable storage medium carrying one or more sequences of instructions which, when executed by one or more processors, cause the one or more processors to perform the steps recited in claim 4.

16. A volatile or non-volatile computer-readable storage medium carrying one or more sequences of instructions which, when executed by one or more processors, cause the one or more processors to perform the steps recited in claim 5.

17. A volatile or non-volatile computer-readable storage medium carrying one or more sequences of instructions which, when executed by one or more processors, cause the one or more processors to perform the steps recited in claim 6.

18. A volatile or non-volatile computer-readable storage medium carrying one or more sequences of instructions which, when executed by one or more processors, cause the one or more processors to perform the steps recited in claim 7.

19. A volatile or non-volatile computer-readable storage medium carrying one or more sequences of instructions which, when executed by one or more processors, cause the one or more processors to perform the steps recited in claim 8.

20. A volatile or non-volatile computer-readable storage medium carrying one or more sequences of instructions which, when executed by one or more processors, cause the one or more processors to perform the steps recited in claim 9.

21. A volatile or non-volatile computer-readable storage medium carrying one or more sequences of instructions which, when executed by one or more processors, cause the one or more processors to perform the steps recited in claim 10.

22. A volatile or non-volatile computer-readable storage medium carrying one or more sequences of instructions which, when executed by one or more processors, cause the one or more processors to perform the steps recited in claim 11.
